(19) United States
(12) Patent Application Publication
(10) Pub. No.: US 2010/0042551 A1
(43) Pub. Date: Feb. 18, 2010

(54) Portfolio Balancing Using Stock Screens

(76) Inventor: Alex Karavousanos, New Hyde Park, NY (US)

Correspondence Address: ROBERT PLOTKIN, PC, 15 New England Executive Office Park, Burlington, MA, 01803, US

(21) Appl. No.: 12/192,306

(22) Filed: Aug. 15, 2008

(51) Int. Cl. G06Q 40/00

(52) U.S. Cl. 705/36 R

(57) ABSTRACT

A stock portfolio balancing system identifies two sets of stocks to compare to each other. For example, the two sets may be generated by applying a stock screen to a stock database at two different points in time. Stocks which are in the first (e.g., earlier) set but not the second (e.g., later) set are identified as stocks to sell. Stocks which are in the second (e.g., later) set but not the first (e.g., earlier) set are identified as stocks to buy. Buy and/or sell orders are placed accordingly into a stock portfolio. The process may be repeated at later times to automatically rebalance the portfolio in accordance with the screen over time.

### BACKGROUND

Many software packages and web sites exist which facilitate researching stocks, trading stocks, and managing stock portfolios. Although the following discussion will focus on financial web sites (which include both sites which provide financial information and sites which act as online brokers), the same points are equally applicable to financial software designed to run on a user's computer. Financial web sites often allow users to:
search for stocks using any of a variety of criteria, such as industry sector, performance history, and dividend yield;
view information about individual stocks and their underlying companies, such as price history, price-to-earnings ratio, and performance relative to industry peers; and
trade (buy and sell) stocks within portfolios maintained within an account associated with the web site.

Researching stocks to purchase can be a daunting task, due in part to the large number of publicly-traded stocks and the number of criteria according to which such stocks may be evaluated. Financial web sites often allow users to search for stocks according to any one or more of a large number of criteria, including but not limited to the stock's industry, sector, current price, 52-week high or low, price-to-earnings ratio, market capitalization, debt-to-capital ratio, whether the stock's Trailing Twelve Month (TTM) P/E ratio is less than the industry average, whether the stock's Price/Sales TTM ratio is less than or equal to the industry average, whether the stock's forward-looking PEG ratio (the P/E calculated with reference to the consensus EPS estimate for the next fiscal year divided by the consensus long-term projected EPS growth rate) is less than 2.00, whether the stock's Average Rating is less than 2.00 and is less than or equal to what it was four weeks ago, and whether the stock's consensus EPS estimate for the current quarter is higher today than it was within the past four weeks. A user might, for example, instruct a financial web site to search for and display all stocks in the pharmaceutical sector with a price-to-earnings ratio lower than ten, and having a current price that is at least 20% above the stock's 52-week low. Such a particular combination of search criteria, which act as a query to a stock search engine, are referred to as a stock “screen,” because the criteria filter or “screen” out stocks which do not match the specified criteria. A web site or other software which can search for and display stocks which match the criteria defined by a screen is referred to as a stock “screening application.”

A user, whether an individual investor or professional portfolio manager, may find it useful to run the same screen on more than one occasion. As a result, many stock screening applications are capable of saving stock screens defined by their users. If a user creates and then saves a particular stock screen using a stock screening application, the user may recall the screen at a subsequent time and instruct the stock screening application to re-run the screen. In response, the stock screening application will search for stocks that satisfy the criteria defined by the screen. In this way, the user is spared the need to re-enter the screening criteria each time the user desires to run the screen. Financial web sites often provide users with predefined screens, such as screens for large-cap stocks or fast-rising stocks, to spare users the need to create such screens manually themselves.

Stock screening applications, in summary, provide investors with user-friendly interfaces for searching for stocks that satisfy criteria of interest, thereby enabling those investors to find stocks of interest more quickly and easily than would be possible if it were necessary to manually define a screen (query) from scratch every time. Stock screening applications, however, typically are limited to searching for and displaying stocks to the user. Once a list of stocks satisfying a screen is displayed, the responsibility for analyzing that list and taking any action in response to it (such as buying or selling stocks from the user's portfolio) falls with the user. As a result, the process of using a stock screening application to manage one or more stock portfolios can be tedious and time-consuming.

### SUMMARY

A stock portfolio balancing system identifies two sets of stocks to compare to each other. For example, the two sets may be generated by applying a stock screen to a stock database at two different points in time. Stocks which are in the first (e.g., earlier) set but not the second (e.g., later) set are identified as stocks to sell. Stocks which are in the second (e.g., later) set but not the first (e.g., earlier) set are identified as stocks to buy. Buy and/or sell orders are placed accordingly into a stock portfolio. The process may be repeated at later times to automatically rebalance the portfolio in accordance with the screen over time.

For example, in one embodiment of the present invention, a computer-implemented method or system: (A) identifies a screen defining at least one criterion applicable to a tradable financial instrument; (B) applies the screen to a database of tradable financial instruments at a first time to identify a first plurality of tradable financial instruments which satisfy the at least one criterion; (C) applies the screen to the database at a second time to identify a second plurality of tradable financial instruments which satisfy the at least one criterion; (D) compares the first plurality of tradable financial instruments to the second plurality of tradable financial instruments; (E) identifies at least one tradable financial instrument to buy based on the comparison; and (F) identifies at least one tradable financial instrument to sell based on the comparison.

In another embodiment of the present invention, a computer implemented method or system: (A) receives first input from a user defining a first plurality of tradable financial instruments; (B) receives second input from the user defining a second plurality of tradable financial instruments; (C) compares the first plurality of tradable financial instruments to the second plurality of tradable financial instruments; (D) identifies at least one tradable financial instrument to buy based on the comparison; (E) identifies at least one tradable financial instrument to sell based on the comparison; (F) buys the at least one tradable financial instrument to buy; and (G) sells the at least one tradable financial instrument to sell.

Other features and advantages of various aspects and embodiments of the present invention will become apparent from the following description and from the claims.

### BRIEF DESCRIPTION OF THE DRAWINGS

FIG. 1 is a dataflow diagram of a portfolio balancing system according to one embodiment of the present invention;

FIG. 2 is a flowchart of a method performed by the portfolio balancing system of FIG. 1 according to one embodiment of the present invention;

FIG. 3 is an illustration of a graphical user interface for defining a stock screen; and

FIG. 4 is an illustration of a graphical user interface for displaying the results of running a stock screen.

### DETAILED DESCRIPTION

As described above, existing stock screening applications typically are limited to searching for and displaying stocks to the user. Once a list of stocks satisfying a screen is displayed, the responsibility for analyzing that list and taking any action in response to it (such as buying or selling stocks from the user's portfolio) falls with the user. As a result, the process of using a stock screening application to manage one or more stock portfolios can be tedious and time-consuming. For example, consider a user who already owns a portfolio of stocks and who wishes to decide whether to purchase any additional stocks to add to his portfolio, and whether to sell any stocks from his portfolio. Such a user may use an existing stock screening application to search for and display a list of stocks which satisfy a particular screen representing criteria that the user considers desirable.

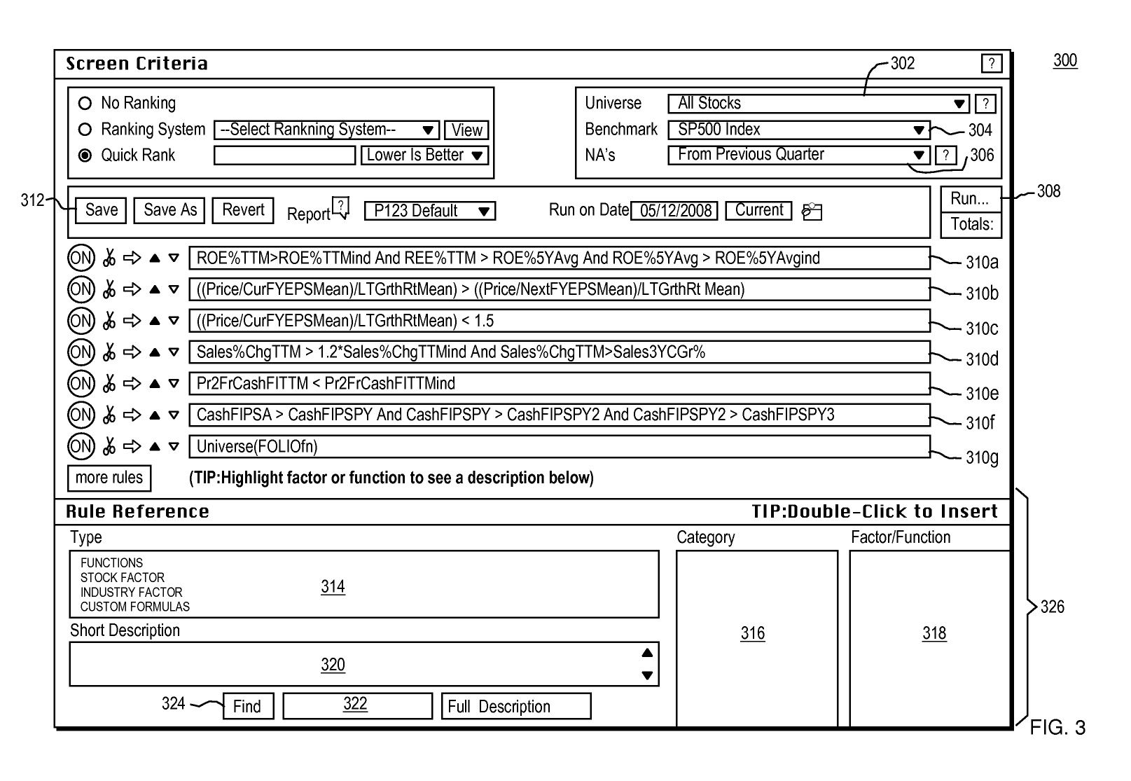

For example, referring to FIG. 3, a graphical user interface 300 for defining a stock screen is shown. The user interface allows a user to select the universe of stocks to screen (element 302), a benchmark to which to apply the screen (element 304), and to run the screen (i.e., query the database using the screen to produce a result set) (element 308). The user interface 300 also includes rows 310a-g which display each of the screening criteria in the screen. For example, row 310g indicates that the screen is to search through all stocks in the universe of stocks available on Foliofn.com. Text in the rows may either be typed by the user in a screening language, or created using the user interface using area 326.

For example, the user may add to or edit the screen by selecting a rule type (element 314), which then causes a category (not shown) to be displayed within box 316 from which the user may select a category. The user will then see and select a factor/function within box 318. When the user completes the selection process, the user's selections are reflected within the current one of the rows 310g. Alternatively, the user may search for factors and functions by typing text in box 322 and clicking on Find button 324. In this way, the user may build a screen without needing to understand how to write a description of the screen in the query language illustrated by the text in rows 310a-g.

Once the user has constructed a screen, he may save it for future user by clicking on a Save button 312. The user may then retrieve and re-run the screen at a later date without having to recreate it. The user may run the screen at any time by clicking on a Run button 308.

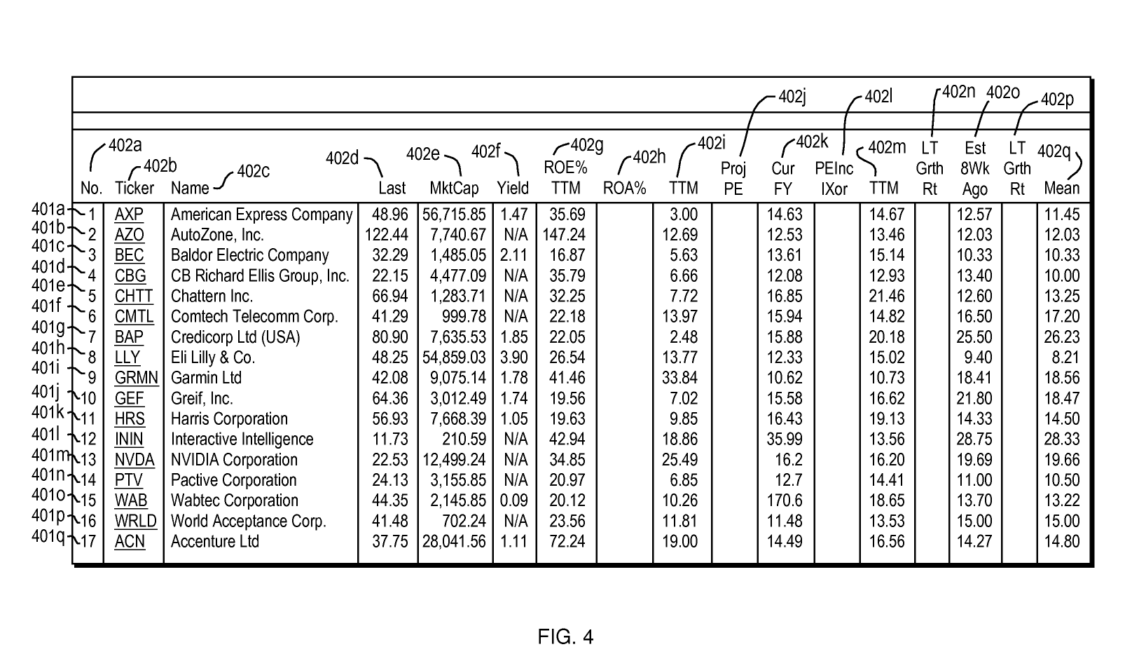

In response to clicking the Run button 308, the stock screening system runs the screen and displays the stocks which match the screen using a user interface such as the user interface 400 shown in FIG. 4. The user interface 400 includes a list of stocks 404a-q which matched the screen. If the results list is too large to fit in a typical window, the user interface 400 may display only a subset of the results and allow the user to navigate to additional results by clicking on a “Next” button or using a similar mechanism. The results list may, therefore, include hundreds or thousands of stocks.

The user interface 400 displays a variety of information about each stock in the results list, such as its position in the list (402a), ticker symbol (402b), name (402c), last share price (402d), market capitalization (402e), yield (402f), and other data fields 402g-q of the stocks in the results list. Note that the particular data fields shown in FIG. 4 are merely examples and do not constitute limitations of the present invention. For example, by default the data fields comprising the screening criteria may be displayed in the user interface 400 for each stock in the results list. This is merely an example, however. The user may customize the data fields that are displayed in user interface 400 to include data fields which are not in the screening criteria. More generally, any data fields may be displayed in the user interface 400, and such fields may be chosen for inclusion in any way.

Once the stock screening application runs the screen and displays a list of stocks satisfying the screen, however, the user must manually analyze that list to decide whether it counsels in favor of buying and/or selling any stocks in the user's portfolio.

Imagine, for example, that the user desires to buy any stocks which are in the screen result list but which are not already in the user's portfolio. To achieve this result, the user may need to manually compare the contents of the screen result list to the contents of the user's existing portfolio and identify stocks which are in the screen result list but not in the user's existing portfolio. The user may then manually place trade orders to buy any stocks identified in this manner. Consider, for example, attempting to compare the lists of stocks in Tables 1 and 2, which represent the results of running the same stock screen at two different points in time. It is clear that attempting to compare such lists to each other manually would be a tedious, time-consuming, and error-prone process.

TABLE 1

| | |
|---|---|
| AIT | Applied Industrial Technologies |
| APD | Air Products & Chemicals, Inc. |
| APU | AmeriGas Partners, L.P. |
| AVT | Avnet, Inc. |
| AXE | Anixter International Inc. |
| CALM | Cal-Maine Foods, Inc. |
| CASY | Casey's General Stores, Inc. |
| CEG | Constellation Energy Group, Inc. |
| CNL | Cleco Corporation |
| CRMT | America's Car-Mart, Inc. |
| D | Dominion Resources, Inc. |
| FDP | Fresh Del Monte Produce Inc. |
| GIB | CGI Group Inc. (USA) |
| GLF | GulfMark Offshore, Inc. |
| HP | Helmerich & Payne, Inc. |
| JAKK | JAKKS Pacific, Inc. |
| LII | Lennox International Inc. |
| MCK | McKesson Corporation |
| NAVG | The Navigators Group, Inc |
| OI | Owens-Illinois, Inc. |
| PCZ | Petro-Canada (USA) |
| PH | Parker-Hannifin Corporation |
| POM | Pepco Holdings, Inc. |
| PRE | PartnerRe Ltd. |
| RIC | Richmont Mines Inc. (USA) |
| RNR | Renaissancere Holdings Ltd. |
| RSCR | Res-Care, Inc. |
| SCSC | ScanSource, Inc. |
| SVU | SUPERVALU INC. |
| UAM | Universal American Corporation |

TABLE 2

| | |
|---|---|
| AIT | Applied Industrial Technologies |
| APU | AmeriGas Partners, L.P. |
| AXE | Anixter International Inc. |
| CALM | Cal-Maine Foods, Inc. |
| CEG | Constellation Energy Group, Inc. |
| CNL | Cleco Corporation |
| CRMT | America's Car-Mart, Inc. |
| FDP | Fresh Del Monte Produce Inc. |
| GIB | CGI Group Inc. (USA) |
| JAKK | JAKKS Pacific, Inc. |
| LII | Lennox International Inc. |
| PCZ | Petro-Canada (USA) |
| PRE | PartnerRe Ltd. |
| RIC | Richmont Mines Inc. (USA) |
| RNR | Renaissancere Holdings Ltd. |
| RSCR | Res-Care, Inc. |
| ACGL | Arch Capital Group Ltd. |
| AGP | AMERIGROUP Corporation |
| AMED | Amedisys, Inc. |
| CNC | Centene Corporation |
| LG | The Laclede Group, Inc. |
| LLL | L-3 Communications Holdings, Inc. |
| MDU | MDU Resources Group, Inc. |
| NEU | NewMarket Corporation |
| NOC | Northrop Grumman Corporation |
| RSC | Rex Stores Corporation |
| SAFM | Sanderson Farms, Inc. |
| SPN | Superior Energy Services, Inc. |
| TPP | TEPPCO Partners, L.P. |
| WDC | Western Digital Corp. |

Conversely, the user may desire to sell any stocks which are in the user's existing portfolio but not in the screen result list. To achieve this result, the user may need to manually compare the contents of the screen result list to the contents of the user's existing portfolio and identify stocks which are in the user's existing portfolio but not in the screen result list. The user may then manually place trade orders to sell any stocks identified in this manner. This can be tedious, time-consuming, and prone to error.

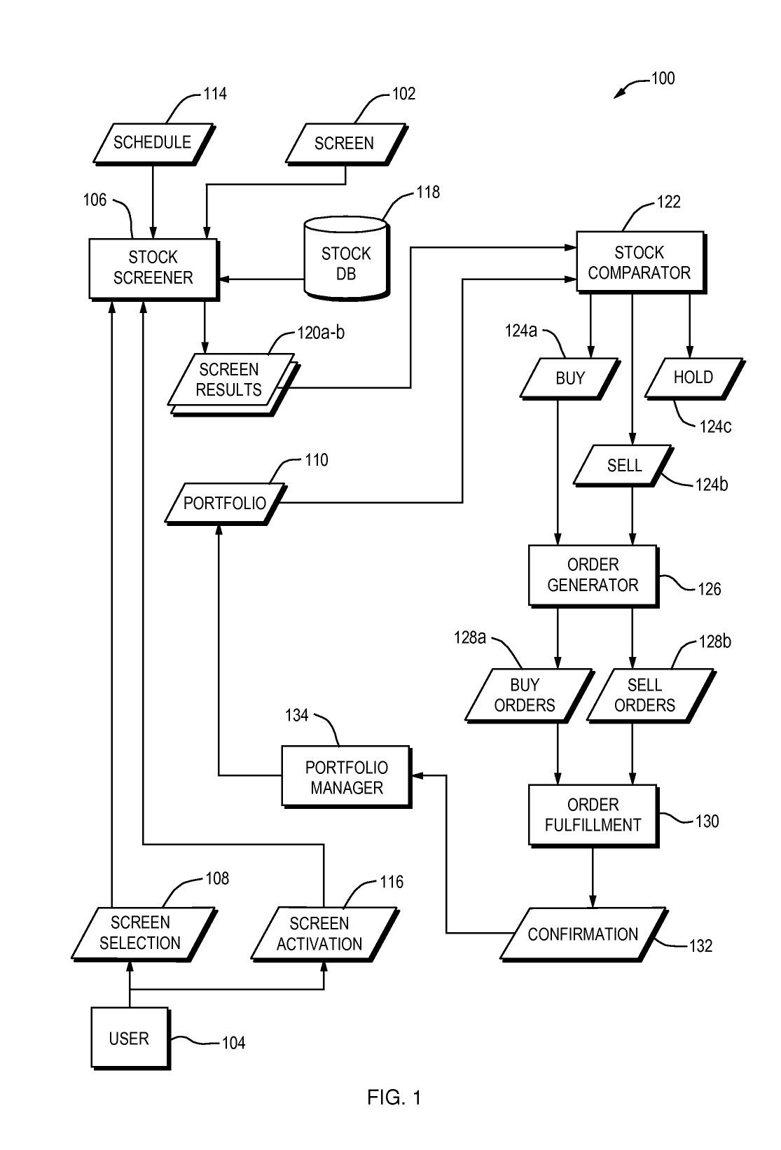

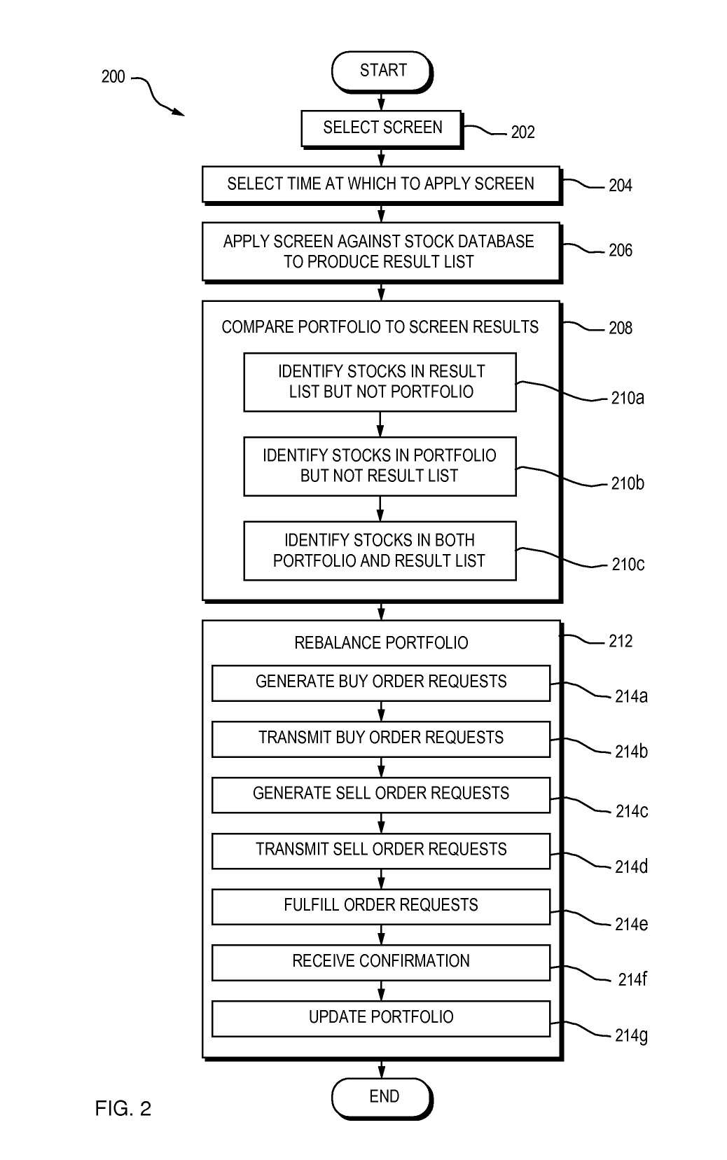

Various embodiments of the present invention address these and other shortcomings in existing systems. For example, referring to FIG. 1, a portfolio balancing system 100 is shown according to one embodiment of the present invention. Referring to FIG. 2, a flowchart is shown of a method 200 that is performed by the portfolio balancing system 100 according to one embodiment of the present invention. The system 100 includes a stock screen 102. The screen 102 may be created in any manner. For example, a user 104 of the system 100 may create the screen 102 by using a conventional stock screening user interface to define one or more stock criteria. As another example, an administrator of the system 100 may predefine the screen 102 so that the screen 102 is available for use by the user 104 and other users (not shown) of the system 100. As yet another example, the user 104 may select a predefined screen and then modify a subset of the screen's criteria to produce the screen 102. Those having ordinary skill in the art will understand how to create the screen 102 in these and other ways. Embodiments of the present invention are not limited to use in conjunction with any particular kind of screen or to use in conjunction with screens created in any particular manner.

The system 100 also includes a stock screener 106 which selects a particular screen for use (FIG. 2, step 202). Assume for purposes of example that the screener 106 selects the screen 102, which may be one of many screens available within the portfolio balancing system 100. The stock screener 106 may select the screen 102 in any of a variety of ways. For example, as shown in FIG. 1, the user 104 may provide screen selection input 108, identifying the screen 102, to the stock screener 106. The screen selection input 108 may take any of a variety of forms, such as selecting a name of the screen 102 from a drop-down list. As another example, when the user 104 creates a new stock screen, the screener 106 may automatically select the newly-created screen as the default screen for the user 104.

The system 100 also includes a portfolio 110 associated with the user 104. The portfolio 110 includes a set of stocks owned by the user 104. The portfolio 110 may be implemented in any of a variety of ways. For example, the portfolio 110 may be implemented as a list identifying stocks owned by the user 104. The portfolio 110 may be maintained at a commercial stock brokerage and made available to the system 100 through an application program interface (API) or other means. In other words, the portfolio 110 need not be contained within the system 100, but may merely be accessible to the system 100. Although the user 104 may own multiple portfolios, the single portfolio 110 is shown in FIG. 1 and described below for ease of illustration and description.

Assume for purposes of example that the stocks in the user's portfolio 110 consist of stocks identified herein simply as stocks A, B, and C, for ease of illustration. In practice, of course, the user's portfolio may include any number of stocks. Embodiments of the system 100 are particularly useful, in fact, when the user owns a large number (e.g., ten or hundreds) of stocks. The system 100 also includes or otherwise has access to a database of stock information 118. The database 118 may, for example, be any of a variety of available sources of electronic data on stocks.

The stock screener 106 identifies a first time at which to apply the selected screen 102 to the stock database 118 (step 204). The screener 106 may select the first time in any of a variety of ways. For example, the user 104 may manually instruct the screener to apply the screen 102 at a particular time by providing screen activation input 116 to the stock screener 106, such as by clicking on an “Run Screen” button in a graphical user interface. In such a case, the first time identified in step 204 may be the time at which the user 104 provides the screen activation input 116.

As another example, the system 100 may include a stock screening schedule 114 which defines times at which the stock screener 106 is to apply the stock screen 102 to the stock database 118 automatically. The schedule 114 may, for example, be defined in terms of a period (e.g., weekly, monthly, or annually) or in terms of specific dates on which to apply the screen 102. Alternatively for example, the schedule may be dependent upon back-tested results obtained when following an existing investment strategy. The schedule 114 may be created in any of a variety of ways. For example, the schedule 114 may be predefined by an administrator of the system 100 or be selected or otherwise defined by the user 104 before commencement of the method 200 shown in FIG. 2. Once the schedule 114 has been defined, the stock screener 106 may refer to the schedule 114 in step 204 to select the first time at which to apply the screen 102.

At or around the selected first time, the stock screener 106 applies the selected screen against the stock database 118 (step 206). In general, the stock screener 106 determines whether each of the stocks in the database 118 satisfies all of the criteria defined by the screen 102 to produce a list of stocks 120a which satisfy the screen 102. Those having ordinary skill in the art will appreciate how to use conventional database querying techniques to apply the screen 102 to the database 118 to produce the screen results 120a.

Assume for purposes of example that the screen result list 120a produced in step 206 consists of stocks A and D. The portfolio balancing system 100 includes a stock comparator 122 which compares the contents of the user's portfolio 110 to the contents of the screen result list 120a to identify differences between the portfolio 110 and the result list 120a (step 208). More specifically, the comparator 122 may identify a list of stocks 124a which appear in the screen results 120a but not in the portfolio 110 (step 210a), a list of stocks 124b which appear in the portfolio 110 but not in the screen results 120a (step 210b), and a list of stocks 124c which appear in both the portfolio 110 and the screen results 120a (step 210c).

In the present example, list 124a would consist of stock D (because it appears in the screen results 120a but not the portfolio 110), list 124b would consist of stocks B and C (because they appear in the portfolio 110 but not the screen results 120a), and list 124c would consist of stock A (because it appears in both the portfolio 110 and the screen results 120a). Note that although in this example each of the lists 124a-c consists of one or two stocks, in general any of the three lists 124a-c may consist of any number of stocks (including zero), and the method 200 is particularly useful when the number of stocks is large.

List 124a represents stocks that should be purchased into the user's portfolio 110 in order to bring the portfolio 110 into compliance with the screen 102. List 124b represents stocks that should be sold from the user's portfolio 110 in order to bring the portfolio 110 into compliance with the screen 102. Finally, list 124c represents stocks that should be held in the user's portfolio 110 to keep the portfolio 110 in compliance with the screen 102. Note, however, that the lists 124a-c need not be generated and stored as discrete lists. Rather, the system 100 may identify individual stocks to buy, sell, and hold using the techniques disclosed herein without ever creating and storing separate lists of stocks to buy, sell, and hold.

The portfolio balancing system 100 may then automatically place buy trade orders for all stocks in list 124a and sell trade orders for all stocks in list 124b, and update the user's portfolio 110 accordingly, thereby bringing the portfolio 110 into compliance with the screen 102 (step 212). More specifically, the portfolio balancing system 100 may include an order generator 126 which generates buy order requests 128a for all of the stocks in list 124a (step 214a) and transmits those requests to an order fulfillment system 130 (step 214b), which may be within or external to the system 100. Similarly, the order generator 126 may generate sell order requests 128b for all of the stocks in list 124b (step 214c) and transmit those requests to the order fulfillment system 130 (step 214d). Note that if either of the lists 124a-b is empty, then the order generator 126 need not generate any corresponding order requests. No order requests need be generated for the stocks in list 124c because those stocks are already in the portfolio 110 and are to be held in the portfolio.

It may be desirable to maintain a particular distribution among stocks in the user's portfolio 110. For example, the user 110 may desire to maintain a portfolio in which all stocks are held in equal dollar amounts. Any of a variety of existing techniques may be used to select the dollar and/or share amounts of orders 128a-b such that a particular portfolio distribution is maintained.

The order fulfillment system 130 fulfills any order requests transmitted it to by fulfilling the requested buy and/or sell orders (step 214e). In the present example, the order fulfillment system 130 would place a buy order for stock D and sell orders for stocks B and C. Upon fulfilling the requested trades, the order fulfillment system 130 transmits one or more order confirmations 132, which are received by a portfolio management system 134 within the portfolio balancing system 100 (step 214f). The portfolio management system 134 updates the portfolio 110 to reflect the trades that have been placed (step 214g), such as by deleting stocks which have been sold from the portfolio 110 and adding stocks which have been bought to the portfolio 110. In the present example, the user's portfolio 110 would consist of stocks A and D upon completion of step 210. As a result, the portfolio 110 matches the screen results 120a upon completion of step 210.

Note that in the present example, we assumed that the user's portfolio 110 initially consisted of stocks A, B, and C. If instead the portfolio 110 was initially empty, then buy order requests 128a would have been placed for every stock in the screen result list 120a, thereby causing the user's portfolio 110 to contain stocks A, B, and C upon completion of step 212.

Although in the example described above the buy/sell orders 128a-b are fulfilled by an automated order fulfillment system 130, this is not a requirement of the present invention. Instead, for example, the order generator 126 may generate human-readable instructions for buy/sell orders and provide those instructions to the user 104, such as in the form of a screen display, text file, or spreadsheet. The user 104 may then place the specified buy/sell orders manually, and then manually update the portfolio 110.

The stock screener 106 may apply the same screen 102 at a second time (step 204). The stock screener 106 may, for example, automatically consult the schedule 114 again to identify a second time at which to apply the screen 102, such as a week or a month after the previous application of the screen 102. Note, however, that the amount of time that passes between successive applications of the screen 102 need not be exactly equal to the period specified by the schedule 114. For example, if the period specified by the schedule 114 is equal to one year and the one-year anniversary of the previous application of the screen 102 falls on a weekend or a holiday, the stock screener 106 may apply the screen 102 on the next business day following that weekend or holiday.

Note, however, that the second application of the screen 102 need not be triggered automatically. For example, the user 104 may trigger the second application of the screen 102 by providing screen activation input 116 to the screener 106 a second time.

Applying the screen 102 to the stock database 118 a second time may result in a different screen result list 120b, since the screen 102 defines criteria which may be satisfied by different stocks at different times. Assume for purposes of example that when the screen 102 is applied for a second time, it results in a list 120b of stocks consisting of stocks A, B, and E. Recall that the user's portfolio 110 now consists of stocks A and D. Therefore, when steps 208 and 212 are applied the second time, the portfolio balancing system 100 will hold stock A, buy stocks B and E, and sell stock D from the user's portfolio 110. The result is that the user's portfolio 110 is again automatically balanced to include the stocks defined by the stock screen 102 at the second time. This process may be repeated any number of additional times automatically and/or in response to input from the user 104.

Although in the example described above, the portfolio balancing system 100 identifies stocks to buy and sell by applying the stock screen 102 and comparing the results of that screen 102 to the contents of the user's portfolio 110, portfolio balancing systems implemented according to embodiments of the present invention are not limited to identifying stocks to buy, sell, and hold in this manner. Rather, the two stock lists that are provided as input to the stock comparator 122 may be generated in any manner. For example, the list to compare to the user's portfolio 110 need not be the output of a stock screener. Rather, for example, the list to compare to the user's portfolio may be provided manually by the user 104 or be a predefined model portfolio. Furthermore, the stock comparator 122 need not use the user's portfolio 110 as the basis of comparison. For example, the stock comparator 122 may compare the previous output of the stock screener 106 to the current output of the stock screener 106 to produce the buy, sell, and hold, lists 124a-c. As yet another example, the user 104 may provide two lists, generated in any manner, to the stock comparator 122 for comparison.

The examples above illustrate how an individual user's portfolio may be balanced automatically over time. Similar techniques may be applied to use a single screen to balance a collection of portfolios, such as a collection of portfolios under the management of a single investment advisor or other portfolio manager. In such a case, the screen 102 may be associated with the collection of portfolios rather than with the single portfolio 110. In such a case, the stock comparator 122 may perform a single comparison—such as a single comparison between the previous and current outputs of the stock screener 106—to generate buy, sell, and hold lists 124c which are applicable to the entire collection of portfolios. Corresponding buy and sell order requests 128a-b may then be generated and executed for all of the portfolios in the collection.

Embodiments of the present invention have a variety of advantages. For example, in general embodiments of the present invention enable users to query financial databases using personalized criteria and then to seamlessly buy all of the stocks that satisfy those criteria. The same criteria may be applied repeatedly and automatically to rebalance the user's portfolio in accordance with the criteria over time. This provides a significant savings in time and effort in comparison to existing systems, which require the user to manually identify stocks to buy, sell, and hold, and to manually place buy and sell orders for those stocks. When a user of a conventional stock screening system uses such a system to produce a list of stocks from a screen, the user typically buys just a few of the stocks in the list because there is no efficient way to buy every stock on the list. Embodiments of the present invention, in contrast, make automatic purchasing of all stocks in a stock screen result list easy and efficient.

Such automated rebalancing makes it feasible for the individual investor to create a personalized investment portfolio that is defined according to personalized criteria and to maintain the composition of the portfolio in accordance with those criteria over time. As a result, the user gains control over his own portfolio, because he does not need to interact with a broker or other investment professional to maintain a portfolio that is defined according to the user's personalized criteria.

The techniques disclosed herein do not limit the manner in which the user can define his portfolio. For example, the user may choose to use a screen as the basis for rebalancing his portfolio. Such a screen may be defined in any way. For example, the user may select the criteria in the screen from scratch, select the screen from a list of predefined screens, or define the screen according to advice from an investment professional. Alternatively, for example, the user may simply provide the portfolio balancing system with a target list of stocks defined without reference to a screen. In response, the system may automatically generate the buy and/or sell orders necessary to bring the user's portfolio into compliance with the target list and automatically place those orders, thereby sparing the user the time and effort required to generate and place those orders.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Although examples described herein refer to stock portfolios, the techniques disclosed herein are not limited to use in conjunction with stocks. For example, the techniques disclosed herein may be applied more generally to any tradable financial instrument, such as bonds, mutual funds, real estate investment trusts (REITs), ETFs, commodities, or any combination thereof.

Although examples above refer to screens which produce binary results—stocks which are either in the result list 120 or not in the result list—this is not a limitation of the present invention. For example, the stock screener 102 may apply the screen 102 to produce a result list which associates scores with the stocks in the list, where each score indicates how strongly the corresponding stock satisfies the screen 102. Buy and/or sell orders 128a-b may be weighted according to such scores. The screen 102 itself may assign different weights to different criteria within the screen 102 which the stock screener 106 may use to calculate the score for each stock. For example, a stock which satisfies a criterion having a high weight may be given a higher score than a stock which satisfies a criterion having a low weight.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) identifying a screen defining at least one criterion applicable to a tradable financial instrument;
(B) applying the screen to a database of tradable financial instruments at a first time to identify a first plurality of tradable financial instruments which satisfy the at least one criterion;
(C) applying the screen to the database at a second time to identify a second plurality of tradable financial instruments which satisfy the at least one criterion;
(D) comparing the first plurality of tradable financial instruments to the second plurality of tradable financial instruments;
(E) identifying at least one tradable financial instrument to buy based on the comparison; and
(F) identifying at least one tradable financial instrument to sell based on the comparison.

2. The method of claim 1, wherein the database of tradable financial instruments comprises a database of stocks.

3. The method of claim 1, further comprising:
(G) providing at least one buy order, requesting purchase of the at least one stock to buy, to order fulfillment means; and
(H) providing at least one sell order, requesting sale of the at least one stock to sell, to the order fulfillment means.

4. The method of claim 1, further comprising:
(G) buying the at least one stock to buy; and
(H) selling the at least one stock to sell.

5. The method of claim 1, wherein (B) comprises:
(B)(1) identifying the first time based on a predetermined schedule; and
wherein (C) comprises:
(C)(1) identifying the second time based on a predetermined schedule.

6. The method of claim 1, wherein (E) comprises identifying at least one tradable financial instrument that is in the second plurality of tradable financial instruments but not the first plurality of tradable financial instruments.

7. The method of claim 1, wherein (F) comprises identifying at least one tradable financial instrument that is in the first plurality of tradable financial instruments but not the second plurality of tradable financial instruments.

8. A computer-implemented system comprising:
screen identification means for identifying a screen defining at least one criterion applicable to a tradable financial instrument;
first screen application means for applying the screen to a database of tradable financial instruments at a first time to identify a first plurality of tradable financial instruments which satisfy the at least one criterion;
second screen application means for applying the screen to the database at a second time to identify a second plurality of tradable financial instruments which satisfy the at least one criterion;
comparison means for comparing the first plurality of tradable financial instruments to the second plurality of tradable financial instruments;
buy identification means for identifying at least one tradable financial instrument to buy based on the comparison; and
sell identification means identifying at least one tradable financial instrument to sell based on the comparison.

9. The system of claim 8, wherein the database of tradable financial instruments comprises a database of stocks.

10. The system of claim 8, further comprising:
means for providing at least one buy order, requesting purchase of the at least one stock to buy, to order fulfillment means; and
means for providing at least one sell order, requesting sale of the at least one stock to sell, to the order fulfillment means.

11. The system of claim 8, further comprising:
means for buying the at least one stock to buy; and
means for selling the at least one stock to sell.

12. A computer-implemented method comprising:
(A) receiving first input from a user defining a first plurality of tradable financial instruments;
(B) receiving second input from the user defining a second plurality of tradable financial instruments;
(C) comparing the first plurality of tradable financial instruments to the second plurality of tradable financial instruments;
(D) identifying at least one tradable financial instrument to buy based on the comparison;
(E) identifying at least one tradable financial instrument to sell based on the comparison;
(F) buying the at least one tradable financial instrument to buy; and
(G) selling the at least one tradable financial instrument to sell.

13. The method of claim 12, wherein the first plurality of tradable financial instruments comprises a first plurality of stocks, and wherein the second plurality of tradable financial instruments comprises a second plurality of stocks.

14. The method of claim 12, wherein (D) comprises identifying at least one tradable financial instrument that is in the second plurality of tradable financial instruments but not the first plurality of tradable financial instruments.

15. The method of claim 12, wherein (E) comprises identifying at least one tradable financial instrument that is in the first plurality of tradable financial instruments but not the second plurality of tradable financial instruments.

16. A computer-implemented system comprising:
means for receiving first input from a user defining a first plurality of tradable financial instruments;
means for receiving second input from the user defining a second plurality of tradable financial instruments;
means for comparing the first plurality of tradable financial instruments to the second plurality of tradable financial instruments;
means for identifying at least one tradable financial instrument to buy based on the comparison;
means for identifying at least one tradable financial instrument to sell based on the comparison;
means for buying the at least one tradable financial instrument to buy; and
means for selling the at least one tradable financial instrument to sell.
